(19) United States
(12) Patent Application Publication
(10) Pub. No.: US 2007/0252071 A1
(43) Pub. Date: Nov. 1, 2007

(54) Flagpole holder for vehicles

(76) Inventor: Hsuan Yao Huang, Tsun Hsiang (TW)

Correspondence Address: TROXELL LAW OFFICE PLLC, SUITE 1404, 5205 LEESBURG PIKE, FALLS CHURCH, VA, 22041, US

(21) Appl. No.: 11/414,237

(22) Filed: May 1, 2006

(51) Int. Cl. H01Q 1/12

(52) U.S. Cl. 248/539

(57) ABSTRACT

A flagpole holder for vehicles comprises a plurality of appropriate-depth insert grooves vertically cut at one side, and a pair of first and second clip sections symmetrically extending at the other side wherein the adjacent side surfaces of the first and second clip sections are kept apart without contact to each other to preset an appropriate-length flexible space there-between, and the internal lateral sides of the first and second clip sections are respectively defined by an appropriate-width abutment surface to fit to a flexible anti-slippery collar thereby. Besides, the first and second clip sections are respectively equipped with a fitting bore relative to the flexible space for the assembly of a locking element and a locked element therewith. Therefore, the flagpole holder can be easily secured onto a handle of various-type vehicles for stable location of pole bodies with flags or pinwheels attached thereto, achieving convenient and versatile application thereby.

### BACKGROUND OF THE INVENTION

The present invention relates to a flagpole holder for vehicles, comprising a flagpole holder made up of a plurality of appropriate-depth insert grooves vertically cut at one side, and a pair of first and second clip sections symmetrically extending at the other side wherein the flagpole holder can be easily secured onto a handle of various-type vehicles for the insertion of pole bodies with flags or pinwheels attached thereto, maintaining a neat appearance of the vehicle as a whole as well as achieving convenient and versatile application thereby. Besides, an anti-slippery collar is sandwiched between the first/second clip sections of the flagpole holder and the handle thereof and flexibly clamped there-between, permitting the flagpole holder to firmly locate onto the handle without the risk of detaching there-from in application.

Conventionally, to fix flagpoles with flags or pinwheels attached thereto onto vehicles for purposes of advertisement or entertainment, flexible binding elements such as iron wires, cloth straps, or rubber tapes are randomly wound around a vehicle body so as to bind or tie the flagpoles onto the vehicle body thereby. In case of a loose fastening, the flagpole affected by the blowing of wind can easily get tilted and even detached there-from while the vehicle is traveling forwards. Thus, great efforts must be exerted to attach the flagpole tightly onto the vehicle, which is not only inconvenient and time-consuming, but may increase the difficulty of dismantling thereof. In addition, the casual fastening of the binding elements into thick layers can ruin the appearance of the vehicle as a whole.

### SUMMARY OF THE PRESENT INVENTION

It is, therefore, the primary purpose of the present invention to provide a flagpole holder for vehicles, comprising a flagpole holder made up of a plurality of appropriate-depth insert grooves vertically cut at one side, and a pair of first and second clip sections symmetrically extending at the other side wherein the flagpole holder can be easily secured onto a handle of various-type vehicles so that pole bodies with flags or pinwheels attached thereto for purpose of advertisement or entertainment can be securely inserted thereto, maintaining a neat appearance of the vehicle as a whole as well as achieving convenient and versatile application thereby.

It is, therefore, the second purpose of the present invention to provide a flagpole holder for vehicles wherein the first and second clip sections are respectively defined by an abutment surface with a flexible space preset there-between to fit to an anti-slippery collar that is further mounted to the handle of the vehicle so that the flagpole holder can be accurately secured in place onto the handle without the risk of detaching there-from, achieving the best state of application thereby.

It is, therefore, the third purpose of the present invention to provide a flagpole holder for vehicles wherein the first and second clip sections are respectively equipped with a fitting bore each connected with the other for the assembling of a locking element and a locked element therewith so as to correspondingly clamp tight the flagpole holder onto the handle of the vehicle, permitting easier and more convenient dismantling as well as assembling of the flagpole holder thereby.

### BRIEF DESCRIPTION OF THE DRAWINGS

FIG. 1 is an exploded perspective view of the present invention.

FIG. 2 is a perspective view of another flagpole holder of the present invention.

FIG. 3 is an assembled cross sectional view of the present invention.

FIG. 4 is a diagram showing the present invention in the state of application.

FIG. 5 is another diagram showing the present invention in the state of application.

FIG. 6 is a cross sectional view of insert grooves shown in another embodiment of the present invention.

### DETAILED DESCRIPTION OF THE PREFERRED EMBODIMENTS

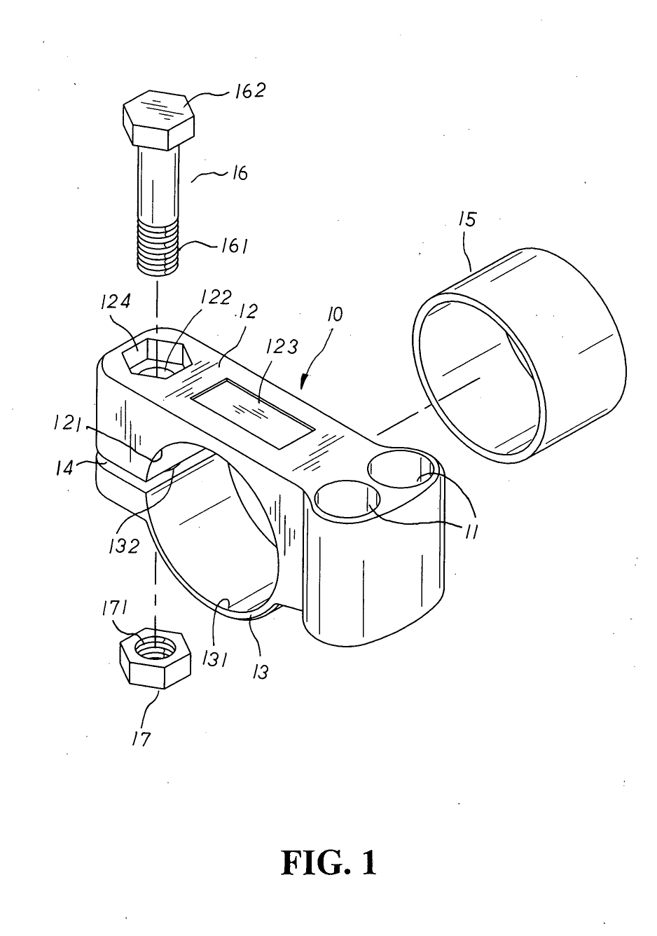

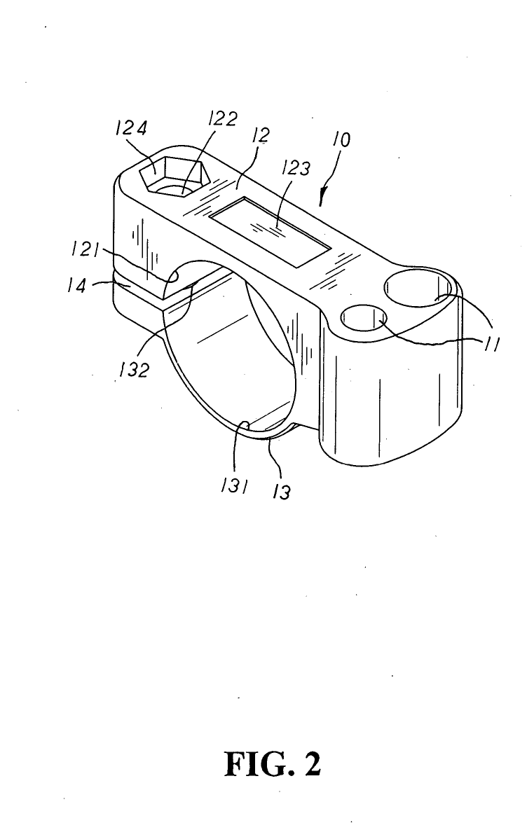

Please refer to FIG. 1 showing an exploded perspective view of the present invention. The present invention relates to a flagpole holder for vehicles, comprising a flagpole holder 10 composed of a plurality of adjacent and appropriate-depth insert grooves 11 vertically cut at one side thereon, and a pair of first clip section 12 and second clip section 13 symmetrically extending at the other side thereon. The insert grooves 11 can be identically made into the same diameter or differently molded into various-size diameters such as one big and one small as shown in FIG. 2. And the adjacent side surfaces of the first and second clip sections 12, 13 are kept apart without contact to each other so that an appropriate-length flexible space 14 can be preset there-between. The internal lateral sides of the first and second clip sections 12, 13 are respectively defined by a first abutment surface 121 and a second abutment surface 131 of an appropriate width that, symmetrically indented at appropriate positions thereon, are situated at one side of the flexible space 14 and can be shaped into various forms such as an arcuate configuration. A flexible and plastic anti-slippery collar 15 is provided to fit to the first and second abutment surfaces 121, 131 there-between. In addition, the first and second clip sections 12, 13 are respectively equipped with a fitting bore 122, 132 vertically extending in a position relative to the flexible space 14 thereof. The top surface of the first clip section 12 is equipped with a shallow-grooved label area 123 for the printing of various letters or figures thereon, and an appropriate-depth polygonal limiting groove 124 connecting with the fitting bores 122, 132 thereof for the assembly therewith of a locking element 16 equipped with a thread section 161 and a polygonal stop head 162 (like a screw bolt). The locking element 16 is secured to a locked element 17 defined by a screw hole 171 thereon (like a screw nut), and the top surface of the first clip section 12 can be evenly aligned with the insert grooves 11 on the same level thereof.

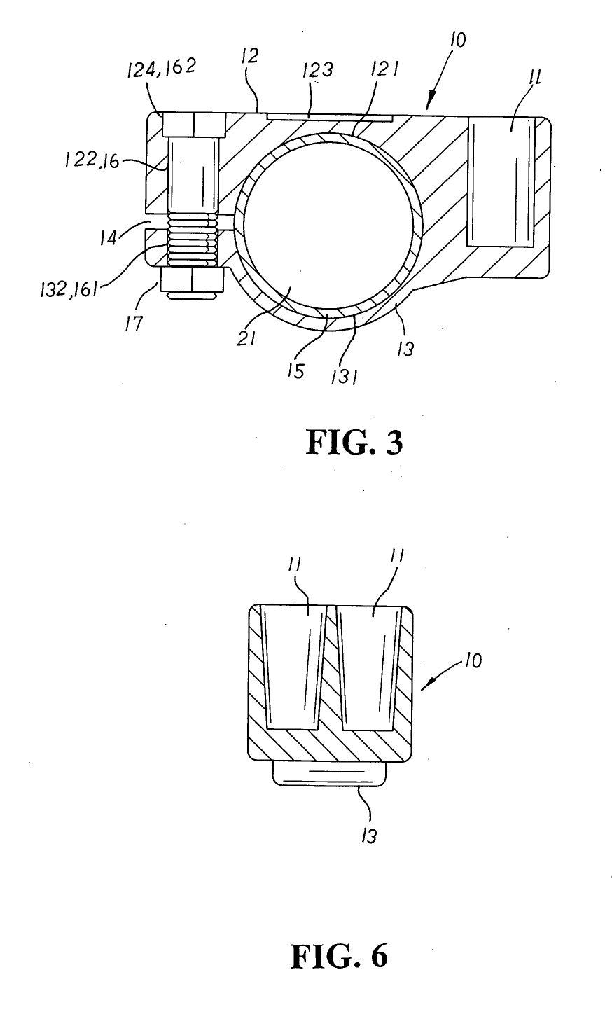

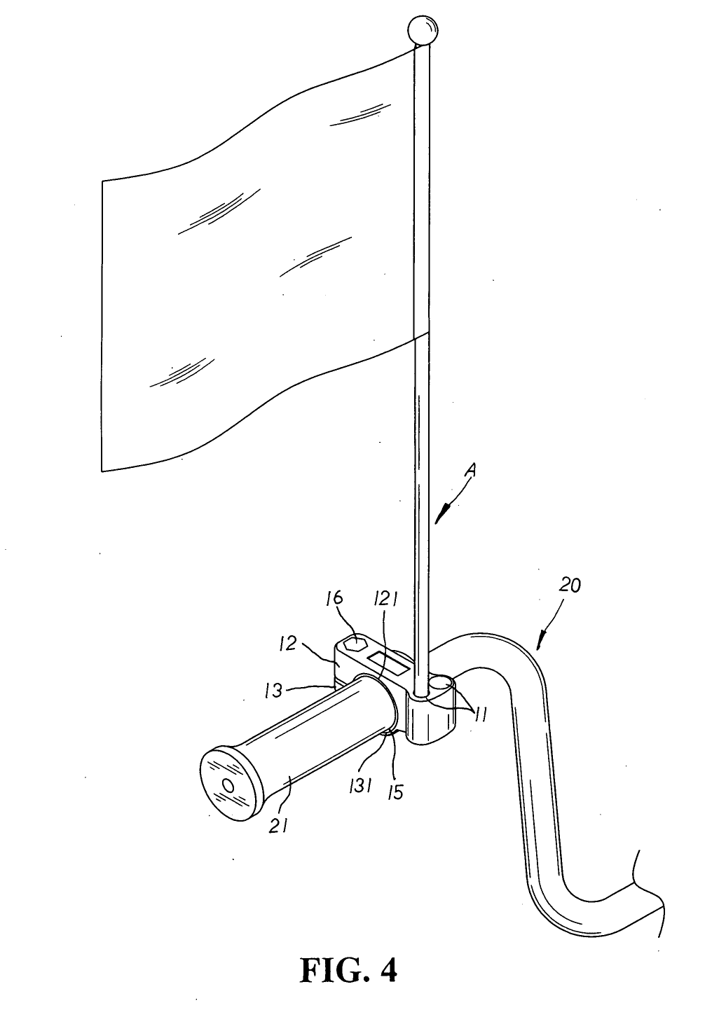

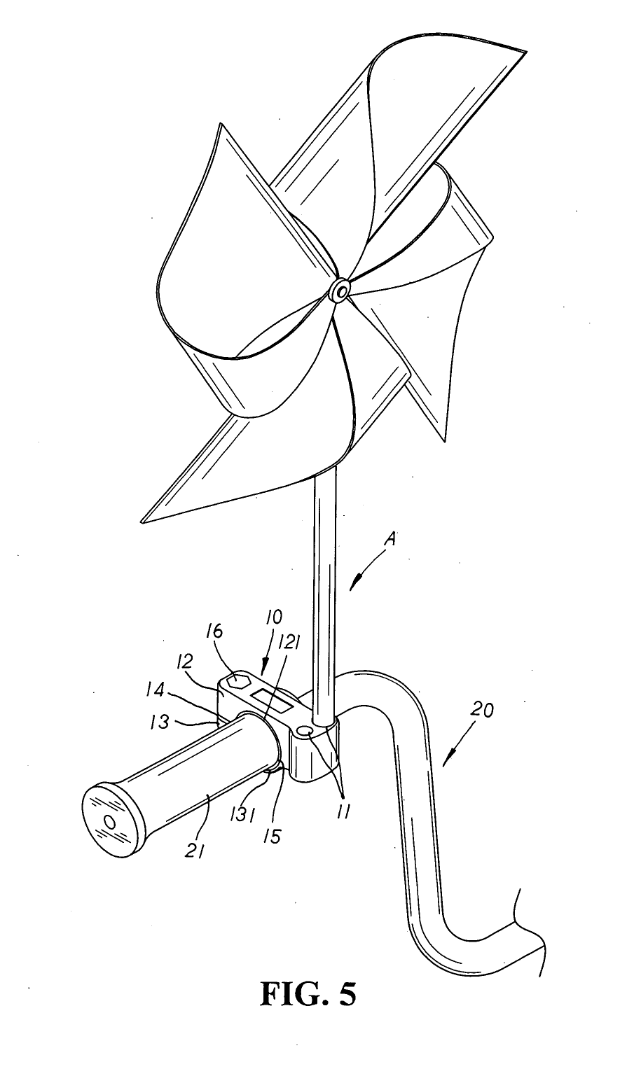

In application (referring to FIG. 3), the anti-slippery collar 15 is mounted to a handle 21 of a vehicle body 20 (such as a bicycle, a motorcycle, and a go-cart). Then, the first/second abutment surfaces 121, 131 of the first and second clip sections 12, 13 are sleeve-joined to the handle 21 from one end till the anti-slippery collar 15 contacts the inner walls of the abutment surfaces 121, 131 and abuts there-between. Via the flexible space 14 preset between the first and second clip sections 12, 13, the abutment surfaces 121, 131 can be flexibly expanded to fit to the caliber-size of the handle 21, permitting smooth and free assembly without any limitations thereof. Then the locking element 16 is sequentially guided through the fitting bores 122, 132 of the first and second clip sections 12, 13 till the stop head 162 is restricted in position by the limiting groove 124 to accommodate therein, permitting the thread section 161 to precisely extend outside the fitting bore 132 of the second clip section 13 thereof. And, the screw hole 171 of the locked element 17 keeps securing up to the thread section 161 of the locking element 16, permitting a corresponding squeezing force generated by the stop head 162 and the locked element 17 thereof to exert onto the flexible space 14 of the flagpole holder 10 so that the abutment surfaces 121, 131 of the first and second clip sections 12, 13 can accurately clamp tight and stably fasten onto the anti-slippery collar 15 and the handle 21 thereof. Meanwhile, the anti-slippery collar 15 is sandwiched between the first/second abutment surfaces 121, 131 and the handle 21, and flexibly clamped there-between, permitting the flagpole holder 10 to firmly locate in place onto the handle 21 without the risk of detachment there-from so as to maintain a neat appearance of the vehicle thereby. Then, depending on the caliber-sizes thereof, various-type pole bodies A with advertising flags as shown in FIG. 4 or entertaining pinwheels as shown in FIG. 5 attached thereto can be fitted into either of the insert grooves 11 for easy installment therein. And, when the flagpole holder 10 is not in use, the screw hole 171 of the locked element 17 is simply unscrewed downwards to detach from the thread section 161 of the locking element 16 so that the flagpole holder 10 can be removed from the handle 21, facilitating easy and convenient dismantling as well as assembling thereby.

Please refer to FIG. 6. The insert grooves 11 of the flagpole holder 10 can also be made into a guiding conic shape so that the caliber of the pole body A can be securely clasped and firmly held in place therein.

What is claimed is:

1. A flagpole holder for vehicles, comprising a flagpole holder having a plurality of appropriate-depth insert grooves vertically cut at one side thereon, and a pair of first and second clip sections extending at the other side thereon wherein the adjacent side surfaces of the first and second clip sections are kept apart without contact to each other so that an appropriate-length flexible space can be preset there-between, and the internal lateral sides of the first and second clip sections are respectively defined by a first abutment surface and a second abutment surface of an appropriate width; in addition, the first and second clip sections are respectively equipped with a fitting bore disposed in a position relative to the flexible space thereof for the assembly of a locking element and a locked element therewith; therefore, the flagpole holder can be easily mounted and secured onto a handle of various-type vehicles, and pole bodies with flags or pinwheels attached thereto can be easily inserted to the flagpole holder and securely held in place therein, achieving convenient and versatile application thereby.

2. The flagpole holder for vehicles as claimed in claim 1 wherein the insert grooves of the flagpole holder can be identically made in the same diameter or differently shaped into various-size diameters such as one big and one small.

3. The flagpole holder for vehicles as claimed in claim 1 wherein the abutment surfaces of the first and second clip sections thereof can be variously shaped into different forms like an arcuate configuration.

4. The flagpole holder for vehicles as claimed in claim 1 wherein the abutment surfaces of the first and second clip sections can be matched and fitted to a flexible and plastic anti-slippery collar.

5. The flagpole holder for vehicles as claimed in claim 1 wherein the top surface of the first clip section can have a label area disposed thereon for the printing of various-size letters or figures thereon.

6. The flagpole holder for vehicles as claimed in claim 1 wherein the label area of the first clip section can be shaped into a shallow-grooved configuration.

7. The flagpole holder for vehicles as claimed in claim 1 wherein the top surface of the first clip section can also have an appropriate-depth polygonal limiting groove disposed thereon to connect with the fitting bores of the first and second clip sections thereby.

8. The flagpole holder for vehicles as claimed in claim 1 wherein the locking element is equipped with a thread section and a polygonal stop head.

9. The flagpole holder for vehicles as claimed in claim 1 wherein the locked element is equipped with a screw hole.

10. The flagpole holder for vehicles as claimed in claim 1 wherein the locking element and the locked element can be respectively made of a screw bolt and a screw nut.

11. The flagpole holder for vehicles as claimed in claim 1 wherein the top surface of the first clip section thereof can be evenly aligned with the insert grooves on the same level.

12. The flagpole holder for vehicles as claimed in claim 1 wherein the insert grooves of the flagpole holder can also be made into a guiding conic shape so as to securely clasp and hold the caliber of the pole body in place thereby.
